(19) United States
(12) Patent Application Publication
(10) Pub. No.: US 2025/0326178 A1
(43) Pub. Date: Oct. 23, 2025

(54) Custom Formed Thermally Insulative Package and Method of Making the Same

(71) Applicant: Little Feet Packaging, Inc., Wilmington, DE (US)

(72) Inventor: Nicholas P De Luca, Sand City, CA (US)

(73) Assignee: Little Feet Packaging, Inc., Wilmington, DE (US)

(21) Appl. No.: 19/116,378

(22) PCT Filed: Sep. 28, 2023
(86) PCT No.: PCT/US23/75436

§ 371 Date: Mar. 28, 2025

Related U.S. Application Data
(60) Provisional application No. 63/377,353, filed on Sep. 28, 2022.

(51) Int. Cl. B29C 53/04

(52) U.S. Cl. CPC B29C 53/04; B29K 2995/0015

(57) ABSTRACT

The techniques described herein relate to a system or method for forming a thermal insulation, the method including: providing a roll of an insulative sheet having a thickness; determining a loop count to obtain a desired insulation characteristic in a pad based on the thickness of the insulative material and an air gap between loops of the insulative material; and forming the pad having a desired length and width by wrapping the insulative material about itself the loop count times. In the method, the air gap is between 0 centimeters and 1 centimeter, the loop count is greater than or equal to one, and the insulative sheet includes one or more of a paper sheet including protrusions, a foamed material sheet, a fibrous material sheet, a cellulose sheet or an encapsulated plastic sheet.

### CROSS-REFERENCE TO RELATED APPLICATIONS AND INCORPORATION BY REFERENCE

The present application is a continuation of International Application No. PCT/US23/75436, filed Sep. 28, 2023, which claims the benefit of U.S. Provisional Application No. 63/377,353, filed Sep. 28, 2022, which are all incorporated herein by reference in their entireties.

### FIELD

The present disclosure teaches a novel method of forming a protective insulating package for use in cushioning and thermally protecting items during shipment. The package formed using a substrate such as polystyrene foam, polyethylene foam, encapsulated air sheet, foam starch, domed paper, corrugated paper, embossed paper and other thermally insulative materials. The substrate rolled into segments that are placed together to form a liner for a box wherein the number of layers or wraps in each segment is a function of the desired thermal insulation required as well as the dimensions of the container. A typical box using 6 total segments, 3 placed in each unit to form two interconnected “C” configurations. Variations of thermal insulation can be made in an on-demand fashion so as to adjust for the box size, the product stored, the thermal substrate used, the length of storage required, the ambient temperature to be experienced, and the weight of the item(s). Each of the segments can also be formed with multiple substrates within a rolled segment and by combining multiple segments with different thermal or constructed properties.

The machine system incorporating a means to secure, wrap, and eject the formed segment that can be further assembled into a finished package. The machine system further adjusting the length of the wrap section and the number of wrap times as well as having means to grip and combine various substrates.

### BACKGROUND

Insulated boxes are used for shipping many thermally sensitive items including food, medicines, reagents, biological specimens, organs, and chemicals. Commonly, boxes made of polystyrene are used in conjunction with ice packs or dry ice to maintain temperature within a given temperature range, generally below 8 degrees C. for refrigerated product or below 0 degrees C. for frozen product. The boxes are molded and shipped to a packer, who stores the voluminous boxes until the time of use.

When considering how to best provide insulation for frozen or chilled items being shipped, it is important to consider how to minimize the transfer of heat from the exterior environment to the interior of the box and the item. Heat is transferred into a package by three primary mean; specifically, through conductive heat transfer, radiative heat transfer, and convective heat transfer. In U.S. Pat. No. 5,535,888, De Luca described the transfer of heat via conductive means and the importance of minimizing the air gap to less 5 mm or approximately 0.2″ to prevent convective air flow. With respect to radiative heat transfer, using materials such as aluminum with a low emissivity value insure that the radiative heat is reflected as much as possible. With respect to conductive heat flow, having a structure that has the least mass as possible and further capable of supporting the product and ice or dry ice away from the exterior is important. Further the total “R-value” of the insulation is directly proportional to the thickness of the insulation material and inversely proportional to the surface area of the panel.

Some products such as TemperPak, Climacell, and EcoStarch use a starch-based foam that is blown to a required thickness (generally 1-2 inches) and then formed into “C” panels. In order to maximize efficiency of the amount of insulation used, various factors including the ultimate destination of the package, the items and quantity of items to be shipped, the box size, and the thermal properties of the insulation need to be considered. Instead, significant inefficiencies exist because of the need to order panels or packages that are designed for the worst-case scenario, for example, the longest travel time, the lightest product, the largest box or the like. As such, a third party logistics company (3PL) purchasing these panels will have to order a minimum truck load quantity and is constrained to a single panel thickness; thus, the thermal properties or “R-value” of the panels cannot be adjusted based on the shipment. These shipments are very bulky and the insulation can take a significant volume of expensive warehouse space when not being used.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

The present teachings disclose a custom formed thermally insulative package and a system of making the same.

In some aspects, the techniques described herein relate to a method for forming a thermal insulation, the method including: providing a roll of an insulative sheet having a thickness; determining a loop count to obtain a desired insulation characteristic in a pad based on the thickness of the insulative material and an air gap between loops of the insulative material; and forming the pad having a desired length and width by wrapping the insulative material about itself the loop count times. In the method, the air gap is between 0 centimeters and 1 centimeter, the loop count is greater than or equal to one, and the insulative sheet includes one or more of a paper sheet including protrusions, a foamed material sheet, a fibrous material sheet, a cellulose sheet or an encapsulated plastic sheet.

In some aspects, the techniques described herein relate to a method, wherein the insulative sheet includes a plurality of insulative sheets and at least one of the plurality of sheets includes a barrier sheet.

In some aspects, the techniques described herein relate to a method, wherein the barrier sheet has a thickness of less than 1 millimeter.

In some aspects, the techniques described herein relate to a method, wherein the barrier sheet has an emissivity value of less than 0.9.

In some aspects, the techniques described herein relate to a method, wherein the barrier sheet includes primarily cellulose.

In some aspects, the techniques described herein relate to a method, wherein the barrier sheet includes a coating to repel water.

In some aspects, the techniques described herein relate to a method, wherein the insulative sheet or the barrier sheet is white.

In some aspects, the techniques described herein relate to a method, wherein the barrier sheet forms air pockets in conjunction with the insulative sheet.

In some aspects, the techniques described herein relate to a method, wherein the determining includes determining a count of the plurality of insulative sheets based on a cushioning requirement of the pad.

In some aspects, the techniques described herein relate to a method, wherein the barrier sheet forms an outer surface of the pad.

In some aspects, the techniques described herein relate to a method, wherein the air gap is provided by the protrusions.

In some aspects, the techniques described herein relate to a method, further including forming the protrusions on the paper sheet by embossing.

In some aspects, the techniques described herein relate to a method, wherein the insulative sheet includes cellulose.

In some aspects, the techniques described herein relate to a method, wherein the insulative sheet is separated from the roll of insulative material.

The method of claim 1 wherein the insulative sheet has an emissivity value of less than 0.9.

In some aspects, the techniques described herein relate to a method, wherein the forming includes adjusting a distance between prongs to form the pad of the desired length and wrapping the insulative sheet around the prongs for the loop count.

In some aspects, the techniques described herein relate to a method, further including receiving, from an input device, the desired length and the desired thickness.

In some aspects, the techniques described herein relate to a method, further including receiving, from an input device, the desired number of wraps.

In some aspects, the techniques described herein relate to a method, further including receiving, from an input device, the desired number of days of transit time.

In some aspects, the techniques described herein relate to a method, further including receiving, from an input device, the product to be shipped characteristics (ie. Length, width, height, weight etc).

In some aspects, the techniques described herein relate to a method, further including receiving, from an input device, the desired number of units to made.

In some aspects, the techniques described herein relate to a method, further including integration into a bag or liner that has a moisture barrier.

In some aspects, the techniques described herein relate to a method, wherein the determining includes determining a desired thickness based on an insulation requirement.

In some aspects, the techniques described herein relate to a method, wherein the pad includes a plurality of pads, each having a respective thickness and a respective length.

In some aspects, the techniques described herein relate to a method, further including lining sidewalls of a container with the plurality of pads.

In some aspects, the techniques described herein relate to a method, further including assembling a pad assembly including the plurality of pads in a pouch.

In some aspects, the techniques described herein relate to a method, further including lining sidewalls of a container with the pad assembly.

In some aspects, the techniques described herein relate to a method for forming a thermal insulation, the method including: providing a roll of an insulative sheet having a thickness; determining a loop count to obtain a desired insulation characteristic in a pad based on the thickness of the insulative material and an air gap between loops of the insulative material; and forming the pad having a desired length and the desired width by wrapping the insulative material about itself the loop count times. In the method, the air gap is between 0 centimeters and 1 centimeter, the loop count is greater than or equal to one, and the insulative sheet includes a sheet including protrusions.

In some aspects, the techniques described herein relate to a method, wherein the sheet includes paper and the protrusions are formed by embossing.

In some aspects, the techniques described herein relate to a method, wherein the protrusions are dome shaped.

In some aspects, the techniques described herein relate to a method, wherein the embossing of the insulative material occurs at the same location as the forming of the insulative pad.

In some aspects, the techniques described herein relate to a method, wherein the insulative material is fed down between the prongs.

In some aspects, the techniques described herein relate to a method, wherein the pad formed is pushed off the progs using a guide plate nested within the prongs.

In some aspects, the techniques described herein relate to a method, wherein the insulative material is fed simultaneously with the barrier material using a driven roller.

In some aspects, the techniques described herein relate to a method, wherein said roller has dimples to correspond to the protrusions of the insulative material.

In some aspects, the techniques described herein relate to a method, wherein the insulative material is guided via use of a guide plate.

In some aspects, the techniques described herein relate to a method, wherein the insulative material is cut simultaneously with the barrier sheet.

In some aspects, the techniques described herein relate to a method, wherein the insulative material and barrier sheet used to make the insulative pad are derived from a roll of material.

It is to be understood that both the foregoing general description and the following detailed description are exemplary and explanatory and are intended to provide further explanation of the invention as claimed. OBJECTS OF PRESENT TEACHINGS

It is an objective of the present teachings to customize and form a thermally insulative package based on product and shipping variables determined at the time of use or packing within a packing facility.

It is an objective of the present teachings to enable the formation of a thermally insulative box from panels formed with one or more layers of one or more insulative materials such as foamed polystyrene, polyurethane, polyethylene, encapsulated air sheet, foam starch, domed paper, corrugated paper, embossed paper and crumpled paper.

It is an objective of the present teachings to allow a user to designate or allow the system to designate the items and location that the item will be shipped to and further form the appropriately sized thermally insulative package with the appropriate R-value to be formed based on said input as well as the amount of chilling medium used (ie. none, dry ice, ice packs, chemical chill packs, etc.).

It is an objective of the present teachings to form an insulative package at the time of use that is customizable based on the size and weight of the product to be shipped.

It is an objective of the present teachings that the substrates can be “built-up” layer by layer in order to provide more or less insulation as defined by a user or a system based on the shipment.

It is an objective of the present teachings that the system allows for the formation of a finished insulative package formed by wrapping a specific number of times in order to maintain a certain thermal performance.

It is an objective of the present teachings that the segments can be placed with a bag to prevent condensation or moisture degrading the insulative substrate.

It is an objective of the present teachings to allow for the formation of cushion segments with adjustable cushioning properties and using one or more types of substrates to form the cushion.

It is an objective of the present teachings that the insulative segments be formed using various substrates including polystyrene foam, polyethylene foam, foam starch, domed paper, corrugated paper, and other thermally insulative materials.

It is an objective of the present teachings that the system allow for the use of paper based products that minimize the conduction, radiative, and convective heat flow.

It is an objective of the present teachings that an automated process can be used to make said thermal insulation package on site close to the time of use so as to minimize storage.

### BRIEF DESCRIPTION OF THE FIGURES

The accompanying drawings, which are included to provide a further understanding of the invention and are incorporated in and constitute a part of this specification, illustrate embodiments of the invention, and together with the description serve to explain the principles of the invention.

FIG. 1 illustrates a thermally insulative pad according to various embodiments.

FIG. 2 illustrates a thermally insulative pad according to various embodiments.

FIG. 3 illustrates a pad assembly according to various embodiments.

FIG. 4 illustrates an assembled box with the liners according to various embodiments.

FIG. 5A illustrates a schematic side view of a pad and a wrap path according to various embodiments.

FIG. 5B illustrates a schematic diagram of a system to make a pad from a first and a second material 2 according to various embodiments.

FIG. 5C illustrates a detail view of a winding system according to various embodiments.

FIG. 5D illustrates a system configured with a winder, raw material, and a guide plate integrated with a bagging according to various embodiments.

FIG. 6A illustrates a schematic drawing of a pad assembly 20 according to various embodiments.

FIG. 6B illustrates a schematic drawing of a horizontal system used to form a pad assembly according to various embodiments.

FIG. 7 illustrates a vertical bagging or wrapping system to form a liner within a sealed package.

FIG. 8 illustrates a layered panel formed without wrapping.

FIG. 9A and FIG. 9B illustrate test chamber results of a package.

FIG. 10A illustrates an isometric view of machine system to make thermal pads according to various embodiments.

FIG. 10B illustrates an isometric view of machine system including a rewinder and a multiple spindle plate to create a wrap that is more circular according to various embodiments.

FIG. 11 and FIG. 12 illustrate the details of winder system including a dispenser, a dimpled roller to drive spacer material according to various embodiments.

FIG. 13 illustrates a method for forming a thermal insulation according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DESCRIPTION

Embodiments are discussed in detail below. While specific implementations are discussed, this is done for illustration purposes only. A person skilled in the relevant art will recognize that other components and configurations may be used without parting from the spirit and scope of the subject matter of this disclosure.

The terminology used herein is for describing embodiments only and is not intended to be limiting of the present disclosure. As used herein, the singular forms “a,” “an” and “the” are intended to include the plural forms as well, unless the context clearly indicates otherwise. Furthermore, the use of the terms “a,” “an,” etc. does not denote a limitation of quantity but rather denotes the presence of at least one of the referenced items. The use of the terms “first,” “second,” and the like does not imply any order, but they are included to either identify individual elements or to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

The present teachings provide embodiments of a novel thermal insulation forming system and method, and features thereof, which offer various benefits. The system including an insulative material that can be wrapped or layered, a wrapping machine that can be adjusted to form adjustable lengths or segments, a packing system to assemble the segments into panels, an input device to allow for the adjustment of the segment length as well as the number of wraps forming the segment based on the insulation and cushioning requirements of the package.

As an example, a 3 lb frozen fish product measuring 5″×7″×1″ is to be shipped from San Francisco to destinations using 1, 2, or 3 day express service. Using a 12″ wide domed paper substrate such as that described by De Luca in U.S. Pat. No. 9,315,312B2, as a substrate and a 40 # white paper separator unrolled at the same time. A user inputs the days required for shipment and manually or automatically selects the box size desired. Selecting a 12″×12″×12″ box for 1 day requires 4 layers of substrate in a box and 4 layers equate to a thickness of approximately 1″. Based on making a 12″×12″×12″ box, the prongs or roll winder is adjusted accordingly to form the following segments:
C panel 1 (12″ wide substrate):
   Segment 1: 10″
   Segment 2: 12″
   Segment 3: 10″
C panel 2: (10″ wide substrate):
   Segment 1: 10″
   Segment 2: 10″
   Segment 3: 10″

In this case two separate rewinders could be used to accommodate the 10″ and the 12″ substrate width or a slitting system could be used to narrow the width of the 12″. Each panel could then be formed by inserting the segments in their correct order within a moisture resistant bag or fold and fill machine to wrap a plastic wrap.

Similarly, if a 3 day shipment was desired with a minimum of 72 hours of protection using 15 lbs of dry ice, the “3-day” selection would be made and the system would calculate the thickness required to make the 12″×12″×12″ box. Assuming that 8 layers are required, or approximately 2″ for the appropriate R-value, the prongs on the roller would adjust accordingly to make the following:
C panel 1 (12″ wide substrate):
   Segment 1: 8″
   Segment 2: 12″
   Segment 3: 8″
C panel 2: (8″ wide substrate):
   Segment 1: 8″
   Segment 2: 8″
   Segment 3: 8″

The mechanical adjustment system for the distance between prongs as the material is wrapped being done automatically based on, for example using a stepper motor encoder. The attachment for the material to the rewinder being done automatically (for example, by using a gripper bar) or manually. The rewinder including prongs that may be offset at the same or different radial distances from the center winding point. The system further including a means for cutting or separating the material from the main roll.

The wrapping or winding of the material versus layering helps to minimize the convective currents by effectively closing the sides and improves the thermal performance. Testing has shown significant improvement with the winding over layering. Use of a high reflective white paper has also enhanced performance between the layers of the substrate; thus winding the single reflective layer between the thermal insulative substrate creates a greater R value for the segment bundle.

The system may further include automatic means for dispensing the correct amount of chilling medium (such as dry ice pellets) into the formed package, automatic means for assembling the panels to form the box, integration with a carton case erector, and automatic detection using means such as a vision system or data scan to determine the product being shipped. The ability to form the thermal insulation package at the time of use further enabling the optimization of the final package to reduce costs. As an example, if the price of the substrate is high, a user may benefit from using more dry ice and a larger package, and as such the system could automatically size a longer package so as to fit more dry ice but reduce the thermal R value of the package.

FIG. 1 is a photograph of a thermally insulative pad 5 formed using domed paper 1 with a dome height of 0.2″ wrapped in conjunction with a white paper 2 having an emissivity value of 0.68 (versus brown kraft paper that has an emissivity value of 0.9-0.95). Pad 5 is formed elliptically around lines 3 and 4 such that an overall length 6 of the pad conforms to a corresponding length of a side wall of a box. The pad 5 includes multiple layers of wrap 8 selectively chosen based on a desired thermal insulative characteristic. Ends 9 and 10 of pad 5 forming a block for heat coming at face 10 from reaching face 11.

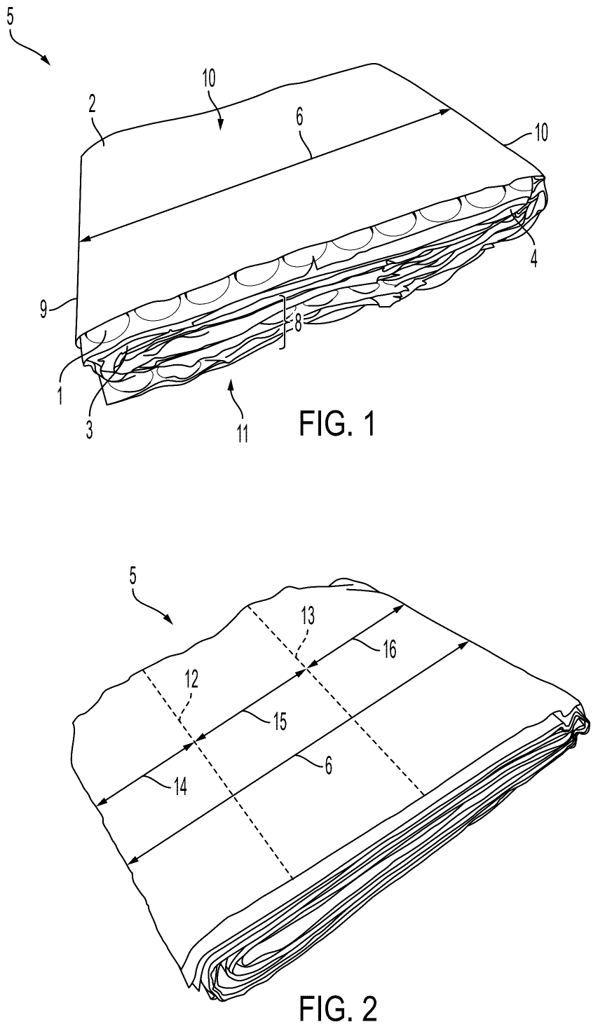

FIG. 2 is a photograph of pad 5 illustrating fold or crease lengths 12 and 13 perpendicular to the length 6. Sections 14, 15, and 16 of thermally insulative pad 5 are formed as a result of folding the pad 5 to simultaneously create sides or a “C” panel to fit, for example, within a box. The folds may form the thermal block line similar to that formed by ends 9 and 10 in FIG. 1. In some embodiments, the folds may be attached, for example, be adhered, sewn or pressed at the line to form a barrier.

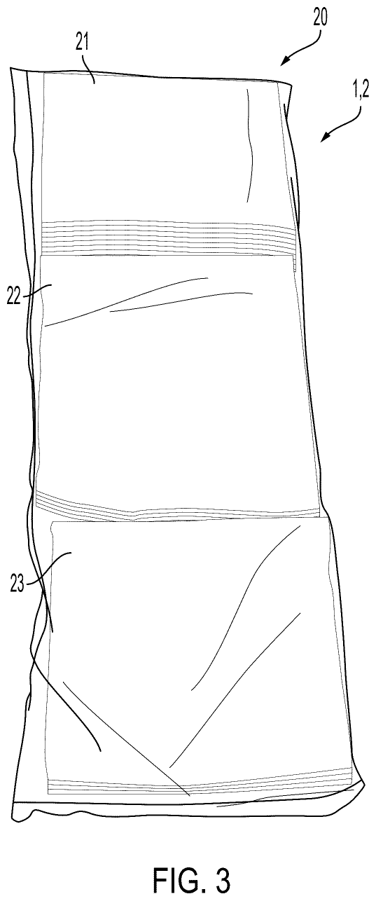

FIG. 3 is a photograph of pad assembly 20 former with three pads 21, 22, and 23 formed into a single pad using paper 2 and domed paper 1 to line a box. Depending on the size and shape of the box to be insulated, the number of layers of combined wraps 8 for each section may change. As an example, a two-day package used to ship frozen items tested at 95 degrees F. at a relative humidity of 75% requires 7 layers on the top and bottom and 5 layers of wrap on the sides.

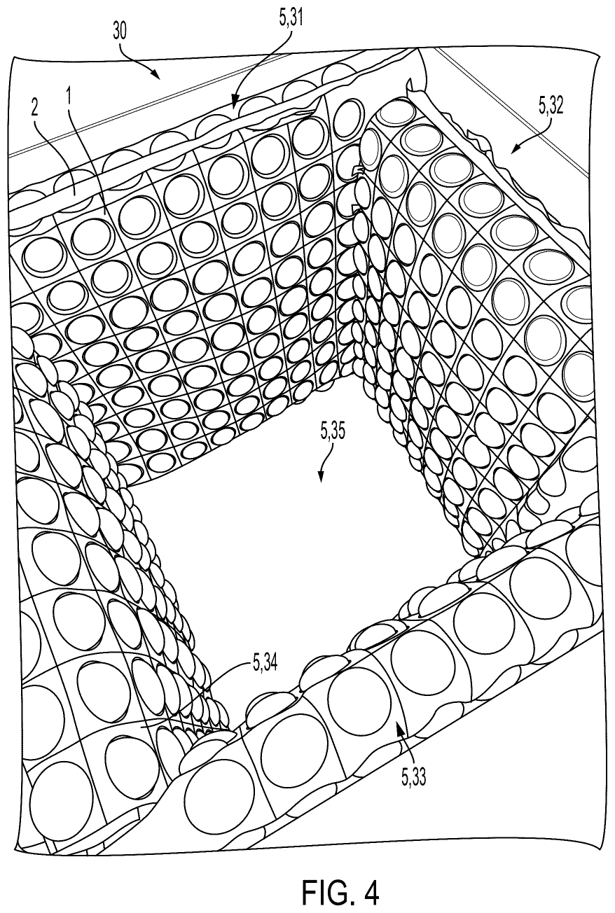

FIG. 4 is a photograph of box 30 lined with 5 pads; pads 31,32,33, and 34 on the sides formed with 5 layers of domed paper 1 and paper 2 and pad 35 with 7 layers of paper 1 and 2. In some cases, an increase in efficiency can be achieved by increasing the width of paper 2 but maintaining the more expensive separator or insulating material at a lesser width. In order to minimize convective currents within the box 30, the insulative material is selected to minimize convective, radiative, and conductive transfer of heat. With respect to the shipping food items in the box, which normally use dry ice or gel packs having a loaded surface area of approximately 0.1-0.2 psi, the insulative material 1 supports said load without or with minimal deformation of the insulative material. The non or minimal deformation maintains a length of the path for conductive heat transfer from a box cavity to an ambient environment.

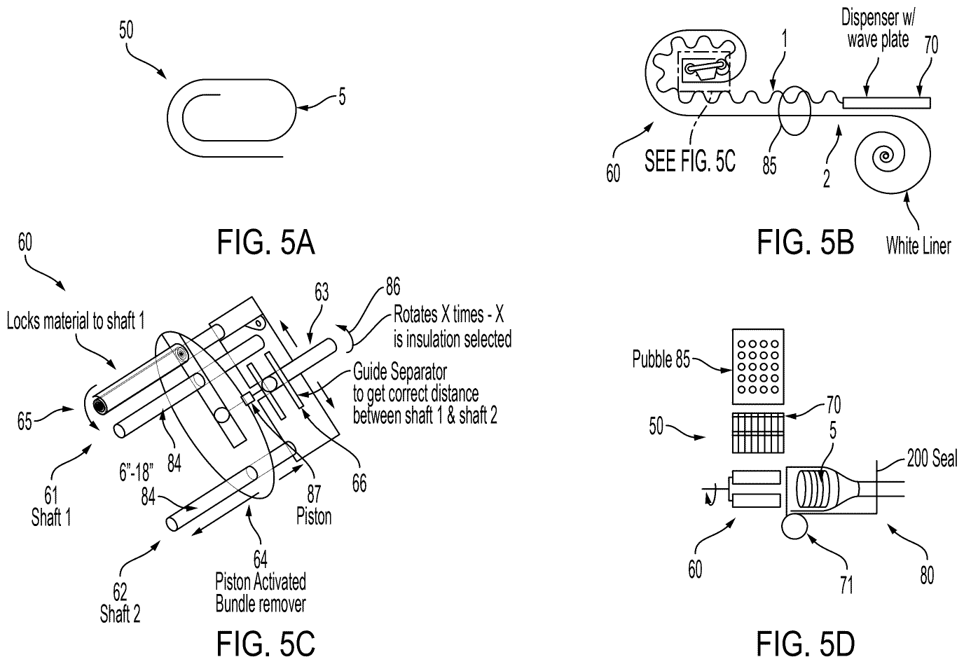

FIG. 5A is a schematic side view of pad 5 and a wrap path used to form the wrap according to various embodiments.

FIG. 5B is a schematic diagram of a system 50 to make pad 5 from a white liner 2 and a raw material 1 using a winding system 60 and a guide system 70 according to various embodiments.

FIG. 5C is a detail view of winding system 60 used to form pad 5. System 60 includes shafts 61 and 62 to form the elliptical edges of 3 and 4 of FIG. 1 upon which material 1 and 2 are wrapped to form the pad 5. Shaft 65 secures the combined material 1 and 2 (as 85) to shaft 61 or 62 as it is fed into the winder. Shafts 61 and 62 may be adjusted manually or automatically to correctly size the pad to be formed based on user input or selection of the pad size. A count of revolutions (X) about axis 86 for raw material 85 is predetermined or selected to correspond to the level of insulation requested. In some cases raw material 85 is fed into area 84 and the rotation of the unit about axis 86 creates a lock of the material based on the protrusions that are on the material 1. Protrusions on material 1 may be provided when material 1 selected from embossed, domed, or formed paper. Shaft 63 of piston 87 is attached to plate 64 such that the finished pad can be pushed off the shaft 61, 62, and 63.

In some embodiments, only one of the material 1 and 2 may be used and as material 85 would not be a combination material. In such embodiments, either material 1 or 2 may be a domed paper.

FIG. 5D illustrates a system 50 configured with a winder 60, raw material 85 (formed per FIG. 5C for example), and guide plate 70. System 50 may be integrated with a bagging system 80 using a wrapping material 71. Wrapping material 71 may be disposed on a roll that is sealed at location 200 to form partitioned sections of pads; for examples the pad assembly 20 of FIG. 3. The sealing at location 200 may be by a heated blade or the like.

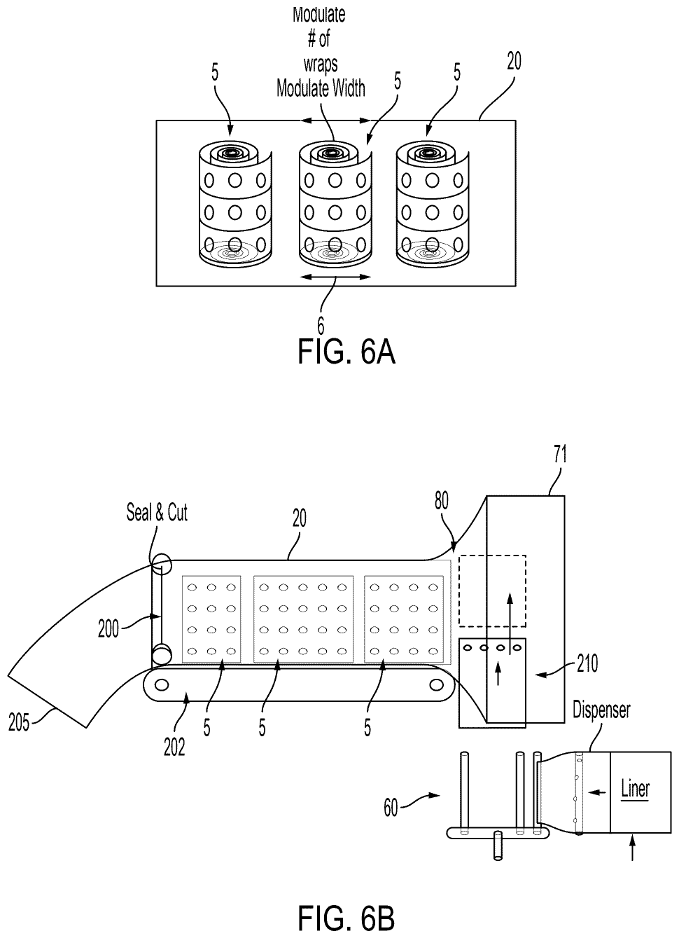

FIG. 6A is a schematic drawing of a pad assembly 20 with pads 5 of varying width 6.

FIG. 6B is a schematic drawing of a horizontal system 80 to form a pad assembly 20. Horizontal system 80 includes unwinding an exterior layer of material 71 upon a conveyor 202 and placing pads 5 within the bag and then sealing at 200. Edge seals can also be added at 205 if an open bag material 71 is used. Plastic as well as coated paper can be used for exterior wrapping material 71 so as to prevent moisture from degrading materials such as embossed paper from moisture condensate at low temperatures associated with dry ice. Pads 5 can be placed on top of the conveyor 202 upon the wrapping material 71 or pads can also be introduced from another direction such as perpendicular to the direction of the conveyor in 210 when produced with winder 60 and ejected in direction 210.

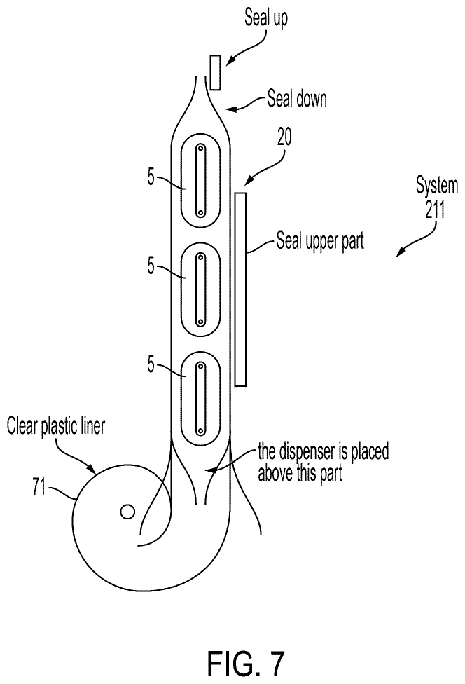

FIG. 7 is a schematic diagram of a vertical bagging or wrapping system 211 to package one or more pads 5 to form an assembly such as assembly 20 using wrapping material 71.

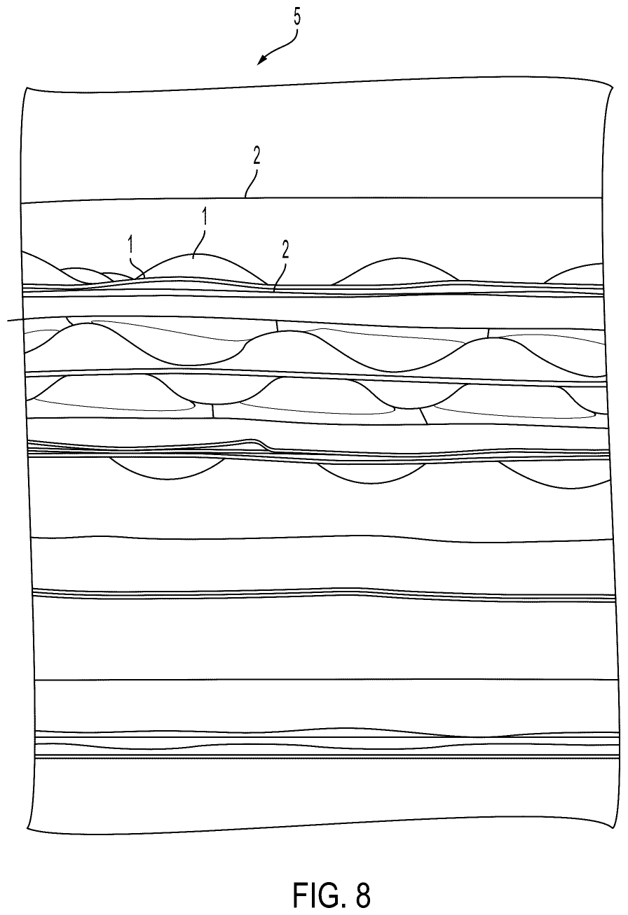

FIG. 8 is a photograph and side view of pad 5 of multiple layers of material 1 layered with material 2. In some embodiments, material 1 may include a domed paper while material 2 includes a undomed paper. In other embodiments, material 2 may include a domed paper while material 1 includes a undomed paper.

The undomed paper may be metallic, glossy, matte or without a finish. The undomed paper may be selected based on its emissivity value. Lower emissivity value (i.e., materials having high reflectivity; for example emissivity value less than 0.3, for example) may be used when a duration of thermal insulation need is high. Exemplary materials with low emissivity include high gloss metallics (for example, aluminum), white paper, white glossy paper or the like. The undomed paper may be made water impermeable with wax, a metallic coating, or the like

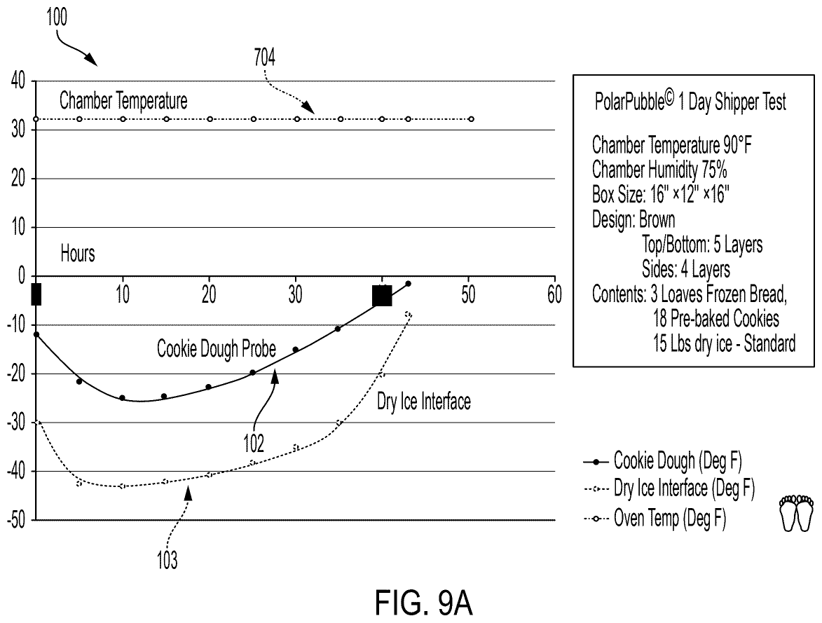

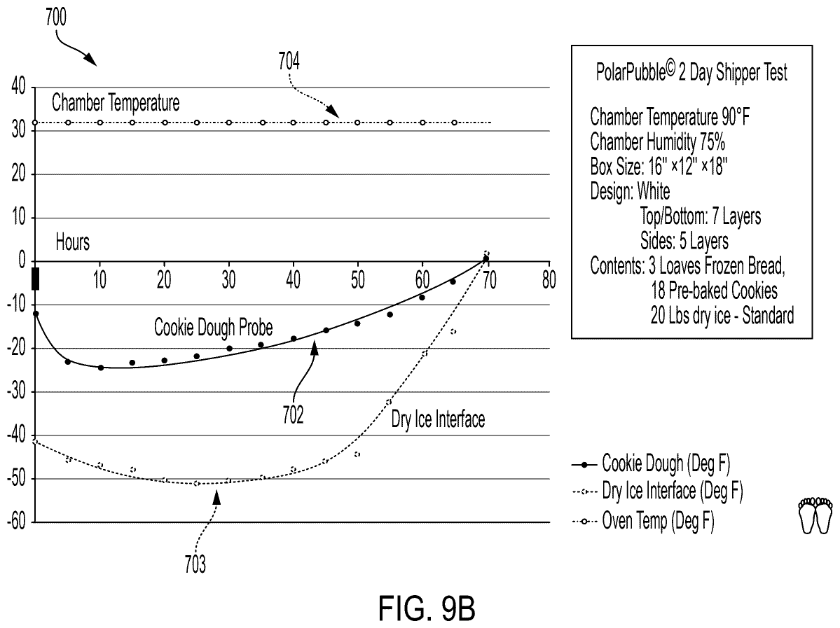

FIG. 9A and FIG. 9B illustrate test chamber results 100 and 700 of a package containing the same items but with a package that is modified based on the time by altering the number of layers of insulative paper dome material and the emissivity and type of barrier paper material use. In 9A, test 100, 15 lbs of dry ice are used and 5 layers of domed paper with brown separation paper having an emissivity of 0.9-0.95 are used for the top and bottom and 4 layers for the sides for a 1-day transit of frozen product. The chamber is recorded at temperature 704 and the temperature in the box and in the cookie sample are recorded with thermocouples 102 and 103.

In contrast, in FIG. 9B, test 700 is shown of a similar box size but where the wraps are increased to from 5 to 7 on the tops and bottom and from 4 to 5 on the sides in order to satisfy a 2-day shipment requirement. In addition, a white paper with a lower emissivity value of approximately 0.68 is used. By switching to the different construction for a two day and minimizing the material for the 1 day, but keeping the same machine setup and insulation, a savings of approximately 25% is accomplished.

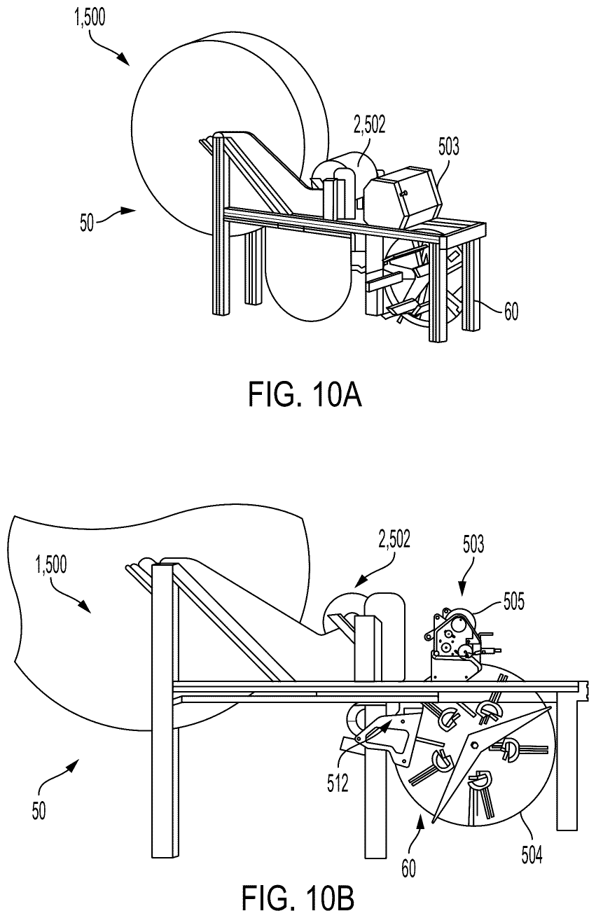

FIG. 10A illustrates an isometric view of machine system 50 to make thermal pads 5 incorporating a roll of insulative or spacer material 1 forming into a roll 500. The liner or separator material 2 in roll 502 is threaded through dispenser equipment 503 and winder 60.

FIG. 10B illustrates an isometric view of machine system 50 with a rewinder 60 formed using a multiple spindle plate 504 to create a wrap that is more circular. By making pads in a circular fashion a sealing mechanism 512 can evenly press on the wrap versus a fork formed by spindles/shafts 61 and 62 shown in FIG. 5C. Dispenser 503 includes a drive wheel 505 to move the spacer material without deformation. In some cases both the liner material 2 and the spacer material 1 can be driven by the same roller 505.

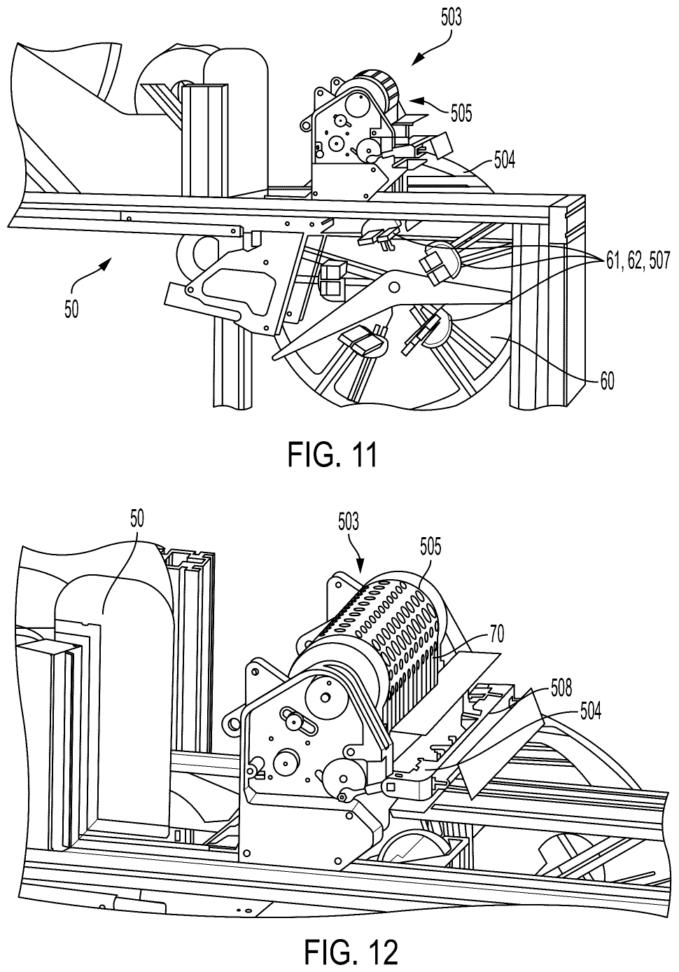

FIG. 11 and FIG. 12 illustrate the details of winder system 50 including a dispenser 503, a dimpled roller 505 to drive spacer material 1 (such as embossed paper, domed paper, plastic bubbled substrate, foam, crumpled paper) and the liner material 2 into the winder section 60 around spindles 507. Spindles 507 further able to be selectively moved either manually or automatically on plate 507 so as to adjust for the correct size of the pad 5. Spindles 507 further able to be selected to form just 2 spindles 61 and 62 of FIG. 5C. Guide plate 70 further used to insure alignment of materials 1 and 2 and cut blade 508 controlled to activate at the correct time to insure a properly cut pad.

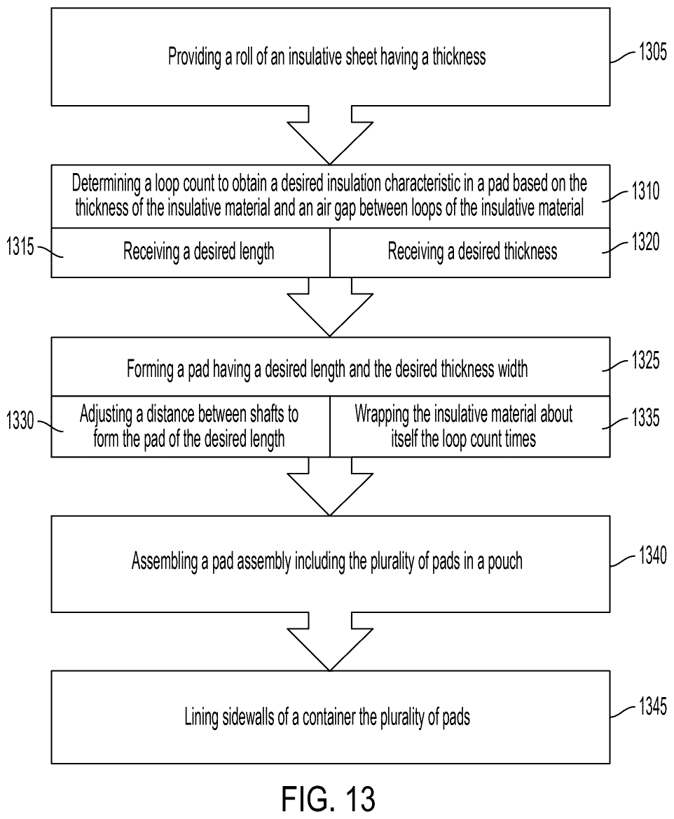

FIG. 13 illustrates a method for forming a thermal insulation according to various embodiments. The method includes operation 1305 for providing a roll of an insulative sheet having a thickness. The method includes operation 1310 for determining a loop count to obtain a desired insulation characteristic in a pad based on the thickness of the insulative material and an air gap between loops of the insulative material. The method includes operation 1315 for receiving a desired length. The method includes operation 1320 for receiving a desired thickness. The method includes operation 1325 for forming a pad having a desired length and the desired thickness width. The method includes operation 1330 for adjusting a distance between shafts to form the pad of the desired length. The method includes operation 1335 for wrapping the insulative material about itself the loop count times. The method includes operation 1340 for assembling a pad assembly including the plurality of pads in a pouch. The method includes operation 1345 for lining sidewalls of a container the plurality of pads.

The examples presented herein are intended to illustrate potential and specific implementations. It can be appreciated that the examples are intended primarily for purposes of illustration for those skilled in the art. The diagrams depicted herein are provided by way of example. There can be variations to these diagrams or the operations described herein without departing from the spirit of the invention. For instance, in certain cases, method steps or operations can be performed in differing order, or operations can be added, deleted or modified.

1-38. (canceled)

39. A method for forming thermal insulation, the method comprising:
providing an insulative sheet having a thickness;
determining a layer count for the insulative sheet to obtain a desired insulation characteristic based on the thickness of the insulative material; and
forming a pad having a desired length and width by layering the insulative material the layer count times,
wherein the layer count is greater than or equal to one, and
the insulative sheet comprises one or more of a sheet having an air gap, a foamed material sheet, a fibrous material sheet, a cellulose sheet or an encapsulated sheet.

40. The method of claim 39, wherein the insulative sheet comprises paper.

41. The method of claim 39, wherein the forming comprises forming the insulative sheet in-line with the forming of the thermal insulation.

42. The method of claim 39, wherein the insulative sheet comprises a barrier sheet.

43. The method of claim 42, wherein the barrier sheet is disposed between two layers of the insulative sheet layers.

44. The method of claim 42, wherein the barrier sheet forms an outer surface of the pad.

45. The method of claim 42, wherein the barrier sheet comprises a coating to repel water.

46. The method of claim 39, wherein one of the layers of the insulative sheet layers is white.

47. The method of claim 39, wherein the determining comprises determining the layer count based on a cushioning requirement of the pad.

48. The method of claim 39, wherein the air gap is between 0 centimeters and 1 centimeter,

49. The method of claim 39, wherein the air gap is provided by protrusions.

50. The method of claim 49, wherein the protrusions are dome shaped.

51. The method of claim 49, further comprising embossing the insulative sheet to form the protrusions.

52. The method of claim 39, wherein the insulative sheet is provided as a roll.

53. The method of claim 39, wherein the insulative sheet has an emissivity value of less than 0.9.

54. The method of claim 39, wherein the forming comprises adjusting a dimension of a mandrel to form the pad to the desired length and width, and wrapping the insulative sheet around the mandrel to obtain the layer count.

55. The method of claim 39, further comprising receiving, from an input device, the desired physical characteristics of the pad.

56. The method of claim 39, further comprising receiving, from an input device, one or more of a minimum loop count, a minimum layer count, a transit time, a characteristic of a product to be shipped, and a desired number of units to be made.

57. The method of claim 39, further comprising integrating the pad into a bag or liner comprising a moisture barrier.

58. The method of claim 39, wherein the pad comprises a plurality of pads, each having a respective thickness and a respective length.

59. The method of claim 39, further comprising lining a sidewall of a container with the pad.
